(19) United States
(12) Patent Application Publication
(10) Pub. No.: US 2014/0344681 A1
(43) Pub. Date: Nov. 20, 2014

(54) Tour Guidance Systems

(71) Applicants: Peter Malcolm Ellenby, San Francisco, CA (US); Thomas Ellenby, San Francisco, CA (US)

(72) Inventors: Peter Malcolm Ellenby, San Francisco, CA (US); Thomas Ellenby, San Francisco, CA (US)

(73) Assignee: GeoVector Corp.

(21) Appl. No.: 13/895,562

(22) Filed: May 16, 2013

(51) Int. Cl. G06F 3/0484; G06F 3/01

(52) U.S. Cl. CPC G06F 3/0484; G06F 3/016
USPC 715/702; 715/771

(57) ABSTRACT

A tour guidance system is formed of a computer-based processor made responsive to location, time of day, manual user inputs, among others to provide visitor site suggestions based upon information stored as site descriptors. In response to user requests in combination with present conditions such as time, location weather, etc., a database request is executed against stored site data to produce a resultset of site descriptors. These site descriptors are used both manually and automatically to assist a user-tourist in executing a visit in agreement with the prescribed parameters.

### BACKGROUND OF THE INVENTION

1. Field

The following invention disclosure is generally concerned with electronic tour guidance systems including equipment and technique and more specifically concerned with an electronic tour guidance systems which provide viewing information to a user in response to various environmental, time and spatial states.

2. Prior Art

Computer technologies have enabled remarkable changes to many of our everyday activities. From how we communicate with our families, to how we plan a journey—computers today greatly influence the manner in which we perform many activities. Even something so enjoyable as sightseeing and touring can be greatly improved and enhanced by way of supporting computer systems. With the advent of inexpensive portable consumer electronics such at tablet computers and small hand-held computing systems, great opportunity arises for tourists to benefit from these advances.

In one illustrative example, an “Electronic Tour Guide and Photo Location 2.5 Finder” is presented by Baron of the Hewlett Packard Company in Palo Alto as U.S. Pat. No. 6,459,388. In this system, the computer database provides information about nearby sites. In particular, sites from which a photograph was made.

In another important patent, inventors Tipnis et al teach of a “Wireless Network Tour Guide”. Issued Dec. 14, 2010 as U.S. Pat. No. 7,853,272, this invention relates a tour guide built alongside location based wireless services which include a message database. A complex scheme to precisely locate the user and provide location information to the user depends upon a location management system used to analyse time of arrival and angle of arrival of various radio transmissions. Short messages (SMS) are provided to the user based upon their present locations as determined by the wireless system.

An interactive multimedia tour guide system is taught by Whitman in U.S. Patent issued on Tuesday, Feb. 25, 2003 and U.S. Pat. No. 6,526,351. The patent entitled: “Interactive Multimedia Tour Guide” teaches of a system which provides users with packaged tours which include “directions and useful information about a selected tour”. This system additionally integrates with a camera.

Another electronic tour guide system is presented as U.S. Pat. No. 4,163,123 in which an electronic tour guide provides messages about exhibits in a museum to visitors carrying portable receivers. Messages are transmitted via infrared energy into a well defined areas near an exhibit.

While systems and inventions of the art are designed to achieve particular goals and objectives, some of those being no less than remarkable, inventions of the art have limitations which prevent uses in new ways now possible. Inventions of the art are not used and cannot be used to realize the advantages and objectives of the invention taught herefollowing.

### SUMMARY OF THE INVENTION

Comes now, Peter and Thomas Ellenby with inventions of tour guidance systems including computing apparatus for directing a tour where the apparatus provides suggestions regarding site visits, points-of-view, courses, history and information, among others. It is a primary function of these tour guidance systems to provide computer based apparatus and methods which respond to various stimuli by providing suggestions to an interested tourist how one may best proceed along a tour.

An electronic tourist's guidance system includes a preprogrammed, application-specific computer arranged to recall data from a library of stored tour descriptors. Tour descriptors are encoded, devised and provided to the library in advance of use of the systems. A tour descriptor includes specification of a tour plan and tour parameters including but not limited to: tour course, site specifications, site information, surrounds information, tour status, and others. Upon various of these program stimuli, the computer by way of a query engine may recall at least one tour descriptor of which certain details may be presented graphically at a user interface such as a display or monitor. In accordance with tour details suggested, a tourist may respond by manipulating her position, attention or focus, in agreement with the tour descriptor details.

A tour such as a walking tour or driving tour is realized where a set of related site or landmark descriptors is presented serially in a manner in which a tourist user can proceed with a visit to a plurality of these sites or landmarks. For example, a plurality of site descriptors all associated with the fine city of Amsterdam, Netherlands may be presented serially whereby a tourist may follow a route which is comprised of each site descriptor in turn moving from one site to the next to be led about the most important landmarks of Amsterdam. Alternatively, a guided tour of these systems may also include a walking tour of a single landmark such as the Coliseum of Rome. A site descriptors each relating to the Coliseum can be dispensed serially with respect to a logical walking path in a manner whereby a tourist may walk about, visiting each site in accordance with the specified parameters, to form a still image visual documentary of a visit to the famous Roman landmark.

In general, these systems are formed of the following electronic modules coupled together as described. A programmed computer arranged with stored application-specific program code and a query engine coupled to a tour library. Query requests produce recall of a resultset including at least one tour descriptor object which contains a tour specification including among others: site list, course, time plan, multi-media object histories, view points, view directions, tour settings, checklists, among others. These tour descriptors may he presented at a display type user interface where partial representations of them may be made visually and/or graphically. A user-tourist may further interact with a resultset of tour descriptors by scrolling through a plurality, for example by way of a control module unit, which further drives code execution with respect to the application.

A tour is presented when a recalled set of tour descriptors relates to a common theme or objective. For example, one type of tour is arranged about various sites of a single city. Presented in a logical order, a plurality of tour site descriptors may be arranged one after another in a series which follows a spatial pattern. For example, a certain tour may be arranged to follow a prescribed tour route. A user-tourist makes a visit to each site in the tour in accordance with tour descriptor details presented to her as it is synchronized with a bus journey. For example, the famous double-decker bus tour of London with well-known routes may be coupled with a tour of systems taught here. That is, a user-tourist deploying these systems may ride a double-decker bus about London while advancing through a provided set of site descriptors in order to provide tourist information relating to the various interesting sites in London.

While providing visitor tours is a primary function of these systems, a secondary but complementary function relates to history lessons. A resultset of site descriptors from which a tour is comprised may include a user request with regard to the historical background of a specific object or feature of a site. Further, this request may include specification of a certain time period of particular interest. In response to these parameters, data including historical information may be provided to a user to advance a user-tourist knowledge about the site and its history.

Visitor tours and history lessons may be provided to a user-tourist upon direct request. For example, a user-tourist may specify “landmark tour of Egypt” from a menu of selections presented at a display monitor device. The computer is arranged to execute an application where such user-tourist choices may be conveyed to the program logic. In response to such choice, the computer recalls a plurality of tour descriptors in agreement with that selection; i.e. tour descriptors which relate to landmarks in Egypt. As an alternative, a user-tourist may set the computer into a “landmark.” mode and the computer can rely upon a GPS position determining system to further specify a request query. That is, rather than a manual selection of “Egypt” a user may rely upon the computer's self determination of location prior to recall of tour descriptors from which a tour is comprised. Indeed, a computer may run in various modes whereby options set by a user are provided in a default scheme or determined by measurement effect a manner in which a set of site descriptors from which a tour or lesson is comprised are recalled. The application supports various modes and each of these modes may cause a different query to be run against data stored in the tour library resulting in different tour plans and history lessons.

In all cases, a programmed computer runs a request query against a library of stored tour descriptors to produce a resultset including at least one site descriptor which may be presented at a user interface to realize a particular visitor tour in accordance with details of the tour specification.

### OBJECTIVES OF THE INVENTION

It is a primary object of the invention to provide a tourist's guidance system It is an object of the invention to provide computer equipment which suggests parameters for visitor tours in response to requests by a user-tourist.

It is a further object to provide computer based consumer electronic equipment with a prescribed library of tour data.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a block diagram of a tour guidance system and its major sub-systems;

FIG. 2 is another important block diagram where a computer based system taught herein;

FIG. 3 illustrate additional important couplings between cooperative related systems and these tour guidance systems;

FIG. 4 presents another block diagram, and

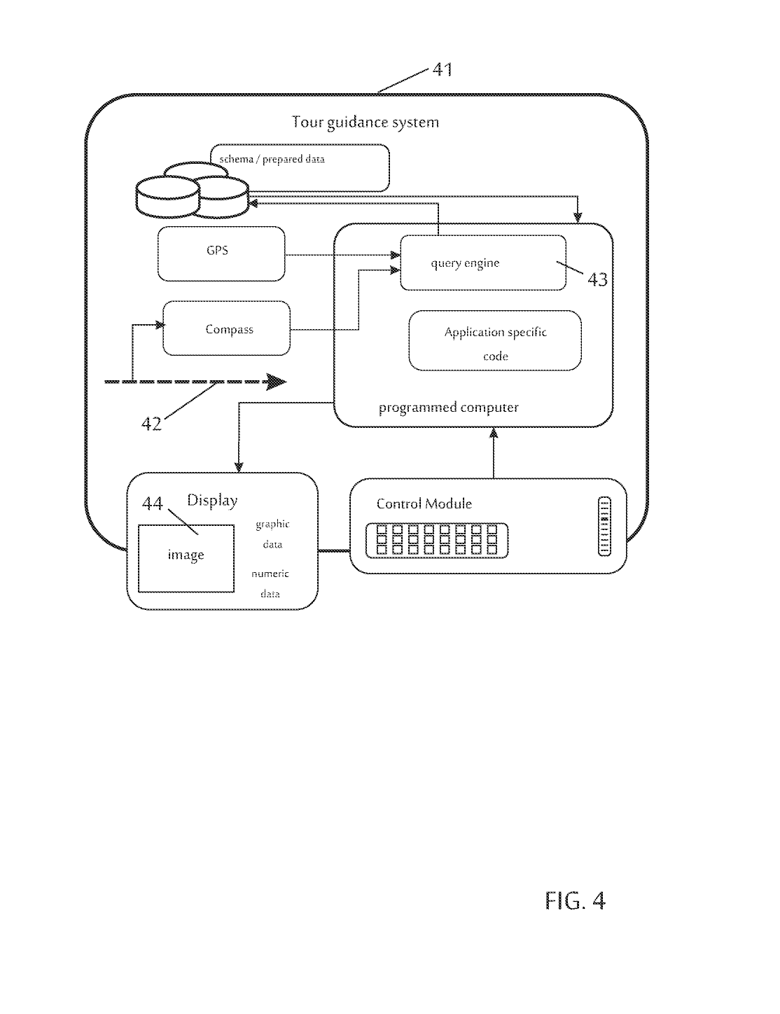

FIG. 5 is yet another block diagram showing major elements of the systems.

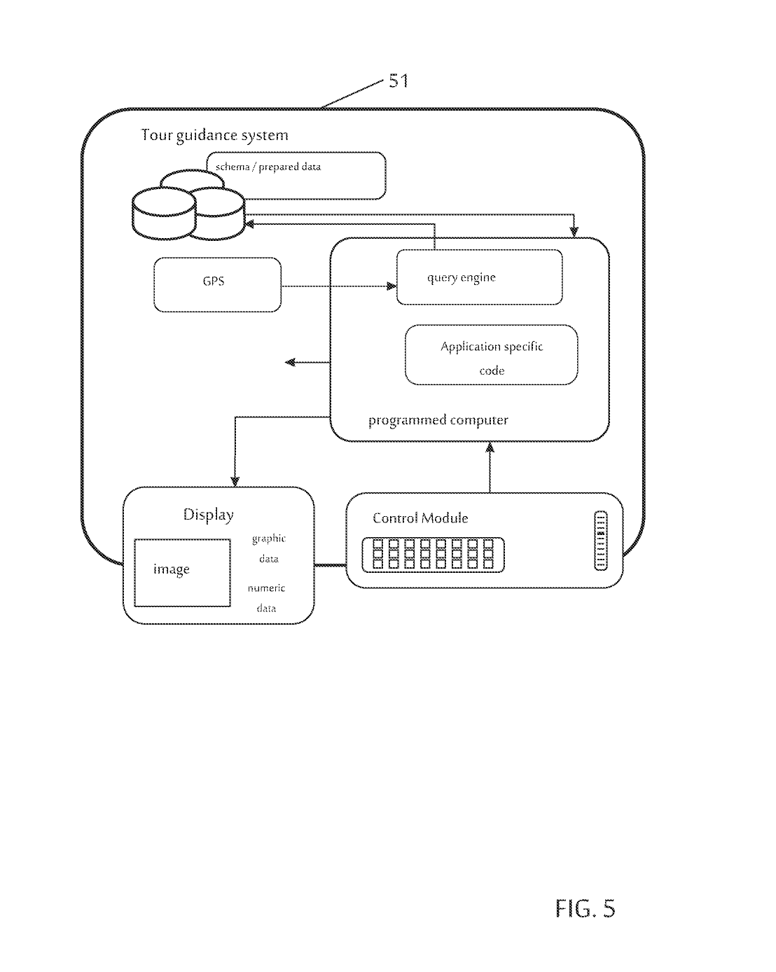

### PREFERRED EMBODIMENTS OF THE INVENTION

In accordance with each of preferred embodiments of the inventions, tour guidance systems are provided. It will be appreciated that each of the embodiments described include an apparatus and methods that the apparatus and methods of one preferred embodiment may he different than the apparatus and methods of another embodiment. Accordingly, limitations read in one illustrative example should not be carried forward and implicitly assumed to be part of any other alternative example.

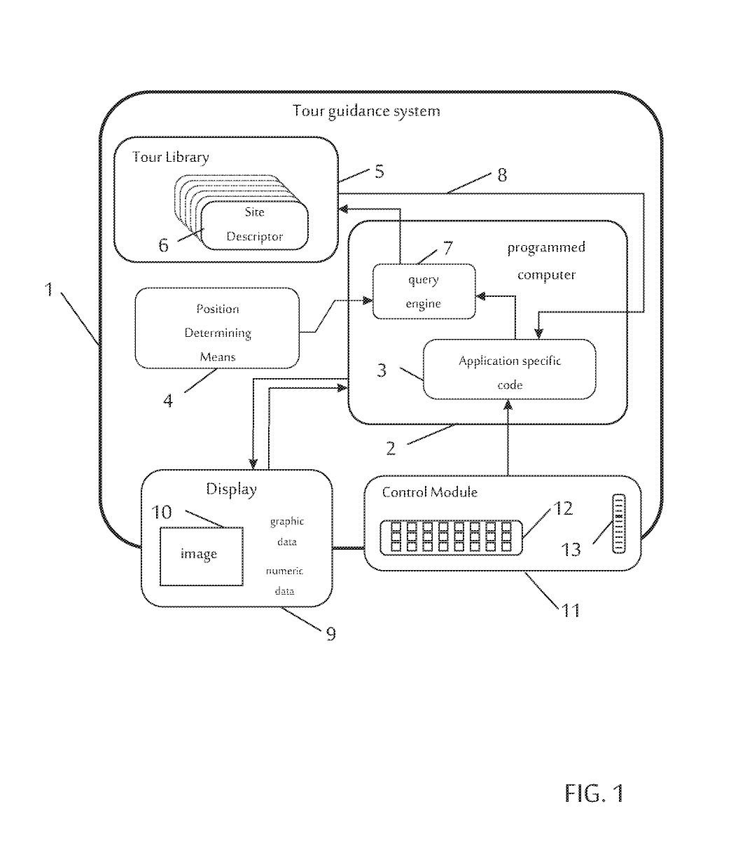

With reference to FIG. 1, one gains a most complete understanding of a general version of these tour guidance systems. An example tour guidance system I is primarily comprised of a programmed computer 2 with application-specific program code 3, a position determining means 4, and a tour descriptor library 5.

Application-specific program code is devised and provided to execute control logic which regulates transactions between various of system components. Code is prepared with knowledge and understanding of system objectives and system architecture with particular respect to tours and attributes of touring. The code which is particular to the structure and nature of all elements taught herein, is stored in a manner whereby it may be executed from time-to-time when the device is performing in normal use.

A position determining means such as GPS receiver is arranged with its reference point coupled with the device—that is, it is set to determine the position/location wherever the electronic appliance is at any given time En most versions this merely means locating the UPS antenna within the system primary hardware. While elements of these systems may be implemented as distributed systems, i.e. in particular the tour library, there is a primary hardware unit which is necessarily mobile and serves as a position reference for cooperating parts.

The tour library 5 includes prescribed data stored in a data storage apparatus and may be deployed as a conventional database. These databases include mechanisms such as custom-designed schema. Stored data includes at least one but usually a plurality of tour descriptors 6. A tour descriptor is comprised of a handle, a parameter list such as name-value pairs, executable code, and sometimes one or more images, videos, and other multi-media data. One most important element of a site descriptor is a geometric construct and definition of a viewpoint or viewing vantage point. There is a one-to-one correspondence between site descriptor data records and viewpoints. That is, each site descriptor includes exactly one viewpoint.

Another important feature of any specific site descriptor is its associations. By way of various parameters or record fields, a site descriptor forms an association with some reference(s). This is useful for sorting operations. In one example, a certain site descriptor may have an association with a location/region—for example: Washington, D.C. In another example, a site data record may have an association with a particular landmark. The Washington Monument is a landmark popular with tourists. For purposes of this discussion, a ‘resultset’ collection of site descriptors is generally particular to some common subject matter which makes a good visitor site such as a landmark like the Washington Monument. Thus, any subject of tourist interest may be represented by a ‘view site’ which contains information about the site and these are part of the site descriptors, it is important to understand that the viewpoint specification of any view site or visit site or ‘object’ is generally not colocated with the actual subject being viewed or addressed. In other words, the location of the site viewpoint is normally different than the position in which the subject of viewing lies.

Many other types of associations are also useful. For example, a certain visit site descriptor may include a seasonal association for example: springtime. Since some objects of interest have particular attributes which are present only in a certain season, for example the cherry blossom bloom of Washington D.C. or the jackoranda bloom in early June in the downtown of San Diego, these sites would have a seasonal marker as part of the site specification or site descriptor. Many other visit descriptor associations will become more apparent in consideration of examples presented in detail herefollowing. It should be further appreciated that while not all possible associations can be described here due to the fact that their number is infinitely great—one will understand that the essence and core of the invention doesn't change when a new type of association is introduced and applied as part of a site descriptor. The principal which is to be clearly understood is that associations may be attached to site descriptors; and sorting and recall based upon such association may be affected.

The position determining means conveys position data to the computer in response to an initialization step and sometimes continuously throughout operation. Based upon position information received, among other information such as association specifications, a query engine 7 forms a database query to recall stored information. A resultset (plurality of site descriptors) 8 is returned to the computer—and this resultset includes all site descriptors which meet the parameter definitions of the query. A resultset may include one or more site descriptors and together these belong to an organized tour.

These visit site descriptors and parts thereof may be reviewed and examined by a user. Application-specific code is arranged to parse the site descriptors and ‘play’ or present them, in example, one-by-one at a display type visual user interface 9. Most particularly, images and video 10 and other multi-media may be presented alongside with graphic and text/numeric data.

While viewing site descriptors, a user may use a control module 11 with tactile peripherals such as a keyswitches 12 or thumbwheel 13 to interact with the application in consideration with the site descriptor presented. For example, a user may ‘select’ a particular site descriptor for further action. Users may interact via user interface with various parts of a site descriptor and the information it contains to express further desire for additional information and content.

These components are preferably arranged into a form and format of a mobile computing package. A mobile computing package is suitable for incorporating a high resolution display type user interface and preferably a touch screen type device. The system is preferably small enough to be held in a single hand with a similar profile like a common mobile telephone. While a common tablet computer like an iPad device is a bit large, it nevertheless remains a useful size to implement this systems. A device such as an iPod nano is too small to contain a meaningful display for purposes of information presentation in accordance with the types of information anticipated.

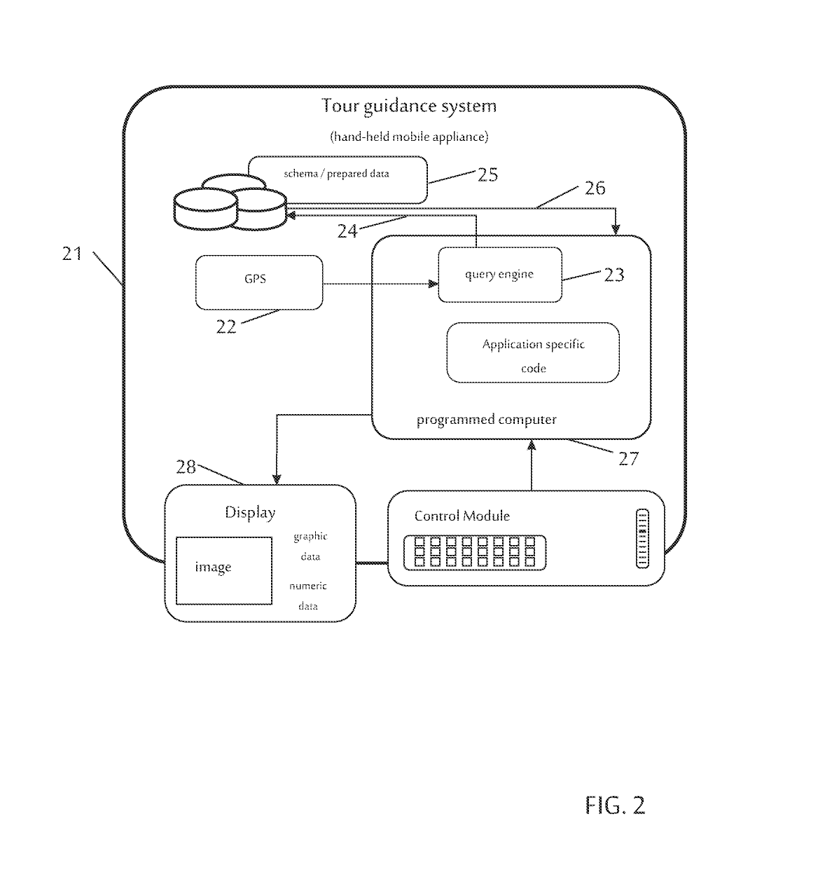

FIG. 2 describes via diagram an important version where the system is directly integrated as a hand-held mobile user appliance. In versions of these apparatus where a tourist's guidance system 21 is integrated as a held-held mobile appliance, control commands generated by the system in agreement with a user selected site descriptors whereby operational states of the appliance are adjusted in accordance with the site descriptor parameter details. In these versions, a GPS 22 for example determines location data with respect to the position of the device and conveys same to the query engine 23 which generates a database query 24 in view of a prescribed arrangement of stored tour data—each unique site having associated therewith a viewpoint spatial construct. That is, the database schema and prepared data 25 are sometimes provided with a consideration of the location and nature front which a site is best viewed according to a prescribed recommendation. Details 26 regarding site viewpoint are passed with a site descriptor to the processor 27 for arrangement and presentation to a user viewer at a display 2 where it may be consumed visually. In addition, other site viewing information may include view orientation, history, site data such as architectural information, hours of operation, et cetera. Recalling from the description of FIG. 1, a user may select one from a plurality of site descriptors from which any particular tour is comprised. Once a site descriptor is chosen, it may be used by the application-specific code to drive the user interface to expose information related to the chosen site. In review, a user may take a mobile unit of these systems to a site of interest and automatically receive viewing suggestions and other information related to the site being addressed. A user may further specify viewing related parameters such as ‘reflections’ to limit or narrow the scope of the subject matter offered as site viewing suggestions. Upon choosing any particular parameter like ‘reflections’ from a group of possible choices in the resultset, the computing system presents the user with details which can be used by the user-tourist to bring about an actual view plan similar to the one suggested In this way, a user can be directed to view that which might include pretty reflections known to be associated with the site of interest being addressed. Foremost among these, is a viewing vantage or site viewpoint. A user may specify that she'd like to view the Washington Monument with a reflection in the nearby reflecting pond. On the selection, the computer directs the user to a particular viewpoint where the user-tourist can enjoy the site from the particular specified parameters. The computer ‘knows’ of this viewpoint because information stored in the tour library have attached thereto a geometric definition of the site and its associated viewpoints. Once a user arrives in the viewpoint location specified by the site descriptor, the device can further present information relating to the site to the user at the graphical user interface. Information presented is particular to the site, and even still further to the precise viewpoint from which the site is viewed.

Another most important aspect of these tour guide systems relates to tour management. In some best embodiments of tours which are comprised of a discrete set of specific sites, the tour is considered complete once each site has been visited. Because some tours may be constructed without a logical path of sites to be followed in sequence, but rather the sites may be visited in a random access scheme, it is useful to include a ‘reporting’ and/or recording mechanism by which site visited are ‘checked off’ a list. A list of the sites from which a particular tour is comprised is maintained with a status feature which indicates that a site visit is or is not complete. As a user goes from site to site, the status is updated or the site is associated with a completed visit. A checklist is ticked to indicate the site visit has been made. The tour which comprises of a plurality of related sites—includes one status state for each to indicate whether or not a completed visit is made, in the way, a user can progress down the list or in any random order to ‘check-off’ those visited sites. By easy reference to the check list of sites/visited sites, a user quickly learns which sites remain due for a visit before the tour is completed.

In some versions, a checklist is operated as an automated system. An electronic determination is made to verify that a site has been visited as part of a tour. When the spatial conditions are met to satisfy some prescribed criteria for a site visit, the checklist is marked as ‘visited’. That is, the status indicator provided to maintain a log, of visited sites is set into a state to reflect the site was visited by the user. For this, the prescribed criteria may include: user location, distance to site, viewing orientation, time of day, among others.

In still another alternative, a user can manually ‘mark’ that a site has been visited in agreement with subjective criteria which may be dynamic in time. For example, a user having less interest in some types of sites which are part of a tour might visit them quite briefly or superficially but still want them to be marked as ‘visited’. A user interface is provided to set/reset the state of the visited status indicators for each site of a tour. The user can maintain this checklist to assist the progress of a selected tour being executed or followed.

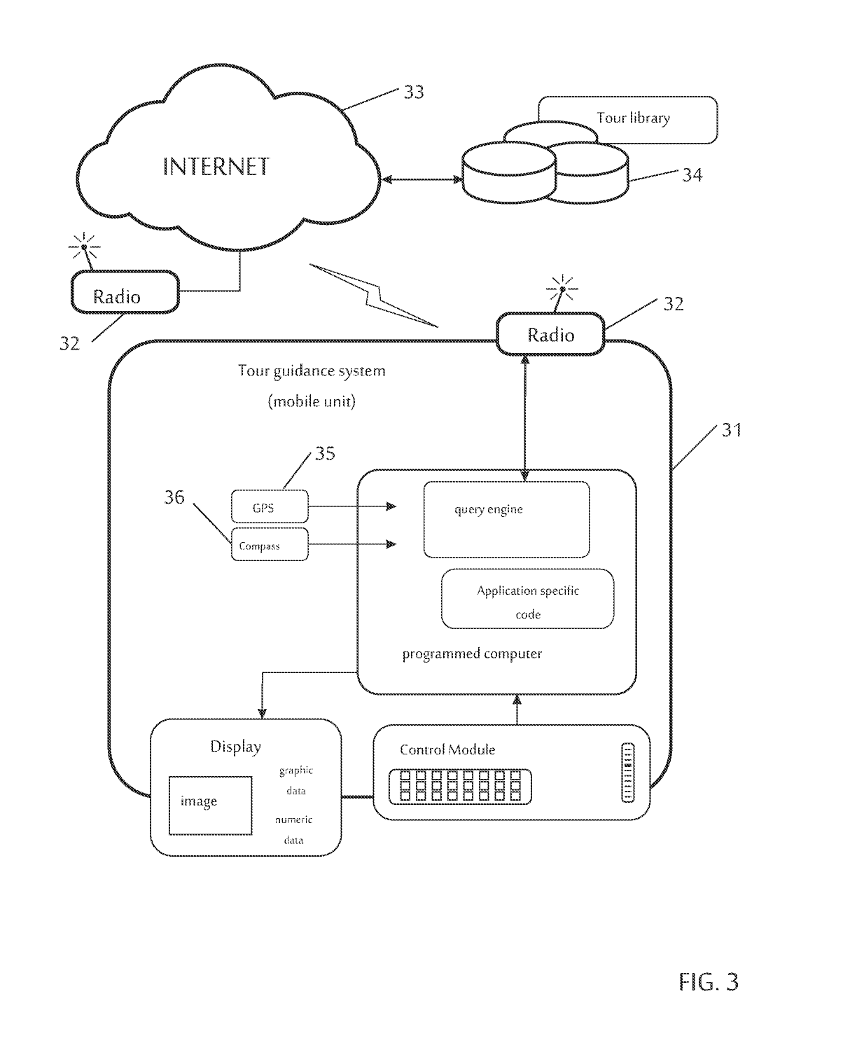

FIG. 3 illustrates important communications aspects of these tour guidance systems 31 Because some comprehensive versions of these systems include very complete libraries of site descriptors including frequent information updates, it becomes convenient to embody them as remote servers. A radio (wireless) communications link 32 is established whereby a mobile device as described is coupled to and exchanges messages with the remote server via the Internet 33. Calls to a remotely located tour library 34 (server) produce a reply over the same wireless communications link whereby the tour guidance system mobile unit receives a limited set of data including a plurality of highly relevant site descriptors. One will appreciate that mobile systems of limited memory and computing resources benefit when coupled to remote servers as described. In addition, self-contained versions with all data on-board are further limited with respect to frequent updates. Remotely deployed tour libraries offer real-time fresh updated data to all users who might couple therewith by a single one-time change at a library arranged as a remote server.

When a mobile unit is carried by a user to a site viewing location or venue, the GPS 35 measures the device's position and reports position data to the application-specific, programmed computer In one special version, an electronic compass 36 may be also included. Device attitude information may also be used in some data queries to request a site descriptors via a more narrowly defined query. If a user-tourist who uses these systems in Washington, D.C. is located at 9th St, NW in the mall facing West, the compass can detect the pointing orientation or attitude of the mobile unit and provide the query engine this information. Thus merely pointing West from this location causes the tour descriptors to be recalled to all have the Washington Monument as a subject of interest However, if the device is turned 180° and pointed East, then the resultset returned only includes site descriptors having the Capitol has a subject. That is, the pointing attitude drives the query engine to recall data which relates to that which is being addressed or pointed at. Accordingly, both position and attitude can be used to form queries to recall specific site descriptors.

In one important version, the compass has a reference direction—for example a virtual line or geometric construct which corresponds to the package centerline—the direction which is subject to the attitude/orientation determination. When the hand-held device is pointed, the compass determines the pointing direction of the device. Accordingly, recalled site recordsets (i.e. a plurality of site descriptors) can depend upon the instantaneous position and attitude of the hand-held device.

In systems 4 taught here, a site descriptor may further include information about the subject of the view being made. A tourist on Alcatraz Island pointing her device West with respect to reference vector 42 would automatically by way of the query engine 43 invoke recall of a site descriptor including a ‘title’ information set associated with the subject matter being viewed; i.e. “Golden Gate Bridge”. Accordingly, “Golden Gate Bridge” can be presented at a user interface 44 as a label for the site being addressed by the tourist. In addition, other information relating specifically to the subject being viewed may also be saved as part of the image file e.g. title; architect; year built; historic evolution, et cetera. If the same user-tourist then turned approximately 180° to face East and make another viewing, a site descriptor recalled would have a subject matter title “Treasure Island”. The user need not know about these titles in advance, the mere act of pointing the camera towards the subject being visited invokes an automatic change to label data displayed at the user interface.

One will now fully appreciate how tour guidance systems based upon computerized processing and stored information operable for making suggested images may be realized. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1) Electronic tour guidance systems comprising:
a programmed computer;
a tour library;
an interactive control module; and
a display type user interface,
said tour library is coupled to said programmed computer whereby stored site descriptors may be recalled and presented at said display type user interface, whereby said recalled tour descriptors characterize and express viewing states of a prescribed and predefined visit opportunity.

2) Electronic tour guidance systems of claim 1, said systems are integrated as a handheld self-contained system.

3) Electronic tour guidance systems of claim 2, in the form and format of a mobile computing package.

4) Electronic tour guidance systems of claim 3, said systems are coupled to remote servers via radio transceivers characterized as WiFi or cellular communications networks.

5) Electronic tour guidance systems of claim 1, said programmed computer is further characterized as comprising executable program code including a plurality of functional methods which may be invoked or called for execution by a control system or menu.

6) Electronic tour guidance systems of claim 1, said site descriptors include definitions of site viewing instances.

7) Electronic tour guidance systems of claim 6, each of said site descriptors are embodied as a program code Objects with prescribed name-value pairs for object properties.

8) Electronic tour guidance systems of claim 6, said viewing instance is further characterized as including viewing states defined by either of: viewpoint, view orientation, and/or time of day.

9) Electronic tour guidance systems of claim 6, portions of said site descriptors are presented graphically at a user interface including a display device.

10) Electronic tour guidance systems of claim 1, further comprises a GPS, said site descriptor recall is based upon current position as determined by the GPS.

11) Electronic tour guidance systems of claim 1, said programmed computer comprises application specific code arranged to administer a visitor tour.

12) Electronic tour guidance systems of claim 11, said visitor tour is characterized as presentation of a series of site descriptors in a logical manner.

13) Electronic tour guidance systems of claim 12, said logical manner includes an orderly spatial plan.

14) Electronic tour guidance systems of claim 12, said logical manner includes plurality of viewpoints all coupled by a common landmark in a ‘walking tour’ characterized as taking place along a continuous walking route or path.

15) Electronic tour guidance systems of claim 13, said orderly spatial plan is characterized as synchronization with either from the group: city bus route; map guide; metro routes; and city tour.

16) Electronic tour guidance systems of claim 1, said programmed computer comprises application specific code arranged to administer a history lesson.

17) Electronic tour guidance systems of claim 16, said history lesson is characterized as an exploration of various time periods.

18) Electronic tour guidance systems of claim 1, said systems further comprising a control module with tactile input systems.

19) Electronic tour guidance systems of claim 6, further comprising a site visit status checklist.

20) Electronic tour guidance systems of claim 19, said checklist further comprises status indicators one for each site, said indicators have binary states to indicate a completed site visit.
